(19) United States
(12) Patent Application Publication
(10) Pub. No.: US 2007/0122333 A1
(43) Pub. Date: May 31, 2007

(54) Ion separation using a surface-treated xerogel

(75) Inventor: Arthur Jing-Min Yang, Lancaster, PA (US)

Correspondence Address: JONES DAY, 222 EAST 41ST ST, NEW YORK, NY, 10017, US

(73) Assignee: Industrial Science & Technology Network, Inc., York, PA (US)

(21) Appl. No.: 11/601,812

(22) Filed: Nov. 20, 2006

Related U.S. Application Data
(63) Continuation of application No. 09/601,888, filed on Aug. 9, 2000, now abandoned.
(60) Provisional application No. 60/074,026, filed on Feb. 9, 1998.

(51) Int. Cl. C01B 33/12; C09C 3/12

(52) U.S. Cl. 423/335

(57) ABSTRACT

Amorphous, nanoporous silica gel having an open channel structure may be surface modified at higher loading of surface modifying ligands, e.g., 7.5 mmole per gram, than known nanoporous silica gels. In one embodiment, an amorphous silica gel has a bimodal pore size distribution of pores at about 10 nanometers and at about 10 microns, and a bulk density of about 0.2 to about 0.25 g/ml. Surface modification with functionalized ligand groups, effective for selective adsorption or reaction catalysis, is achieved by gelling silica sol solution to form a wet silica gel, maintaining the gel at a relatively low elevated temperature in a moist state to obtain a wet nanoporous silica gel having a plurality of open channels within the gel structure and silanol groups on the surface and reacting the surface silanol groups with the ligand group to introduce the functionalized group. The surface modifying reaction may be carried out concurrently with the gelling of a silica precursor in an aqueous alcoholic medium. 3-mercaptopropyltrialkoxysilane is an exemplary ligand introducing compound. The chemically surface modified gel may be used, for example, to remove or concentrate metallic substances in a liquid, or to separate two or more metallic impurities from a mixture thereof, or for cleanup of oil or chemical contaminants from the surface of a body of water.

This application claims priority from U.S. provisional application Ser. No. 60-074026, filed Feb. 9, 1998, the entire disclosure of which is incorporated herein by reference thereto.

For purpose of the United States Designated Office, this invention was funded in part by a government grant from the Small Business Administration and the U.S. government retains certain rights to this invention.

### TECHNOLOGY BACKGROUND AND COMPARISON WITH ART

The most efficient way of removing metal ions from a solution is to first adsorb the ions onto the surface of a solid and then remove or regenerate the solid after it is fully loaded with the target ions. Such a method can be applied to water purification in a continuous operation with water flowing through a column or over a fixed bed of the solid adsorbent. Commercial ion-exchange resins are examples of this approach. Recent developments in this technical field include the incorporation of molecular recognition functional species (i.e. metal-binding ligands) onto the surface of various inorganic or organic carrier materials to achieve the selective adsorption of a particular group of ions from the background ions. Of all the carrier materials explored in this field of application, the synthetic silica gel is the most widely studied. This is because the synthetic nanoparticle silica contains a large amount of active silanol groups on the surface which is necessary for the incorporation of metal-binding ligands and the required high surface area necessary for achieving rapid high-capacity adsorption.

Although much prior art has been developed based on the principle of incorporating metal-ion binding functional groups onto the surface of nanopore silica, the characteristics of the resulting silica-ligand composite products may differ significantlyl^{1,2,3,4,5,6,7} depending on the routes of processing. Different processing techniques may start with silica gels similar in porosity and specific surface area (surface area per gram of silica) but could end up with products of distinctly different loading of the ligand groups. Or, two composites may contain a similar amount of loading of functional groups and yet differ considerably in adsorption efficiency. For the chemical modification of high surface area silica such disparities exist primarily due to the effects of high interfacial stresses as well as the condensation reaction of surface silanol groups under the enormous stresses. The stress produced by the interfacial tension on the solid matrix is quite high. From the following conjecture, we know the capillary stress is inversely proportional to the pore size. For nanometer size pores the stress can be in the range of 100 Mpa.

$$\begin{matrix}Pore Dimension \approx r , Surface Tension \\ = σ \\ Stress = \frac{Force}{Surface Area} \\ Stress \approx \frac{σ r}{{r}^{2}} \\ \approx \frac{σ}{r}\end{matrix}$$

Structure collapse may occur due to excessive capillary stress and the condensation among silanol groups at the surface. The shrinkage and the subsequent condensation reaction not only reduce the surface area, but also close off many channels, reducing access of the inner surface to the diffusion of large molecules.

The morphological details of the silica-ligand composite dictate the adsorption efficiency of the composite adsorbent because a high adsorption efficiency would require the following:

(i) a large number of pores,

(ii) a high loading of functional (ligand) groups on the pore surface,

(iii) many open channels connecting those pores; allowing an easy access for target ions to reach and bind the ligands on the pore surfaces.

To maintain open pore-connecting channels while making a silica-ligand composite is the most critical and challenging task required for achieving high performance in adsorption. Yet, normally, the openness of the interconnecting channels is not adequately characterized for a composite product because the degree of openness for a channel is relative to the size of the transporting species. The ultimate test of whether the channel is open enough or not in a silica-ligand composite is its performance during the test for adsorption efficiency.

A wet low-density silica gel normally contains a porous open-cell structure. Water flows and ions diffuse freely within this kind of open structure. Thus, the entire surface area of the pores can be accessed rapidly. The open porous structure will increase the efficiency and speed of ion adsorption in a water treatment operation. In addition, such an open structure is necessary for the incorporation of large functional groups onto the entire surface. Without an open structure, the incorporation of the functional groups in the preparation of the silica-ligand composite and the binding of targeted ions onto those ligands in a treatment operation become extremely slow and inefficient. The prior art includes many attempts to graft various ligand groups onto the surface of porous silica for ion-specific adsorption. However, because of the inefficiency, the loading and adsorption capacities of those ligands were consistently lower than 1 mmole per gram of silica^{8,9,10,11,12,13,14,15,16}.

During drying of a gel, capillary stresses resulting from the surface tension of the meniscus in the pore can shrink and crack the nanopore material. The shrinkage becomes irreversible when crosslinking occurs with the condensation reaction of the surface silanol groups. Known treatments to reduce shrinkage include lowering the interfacial tension and minimizing the condensation reaction occurring among the surface silanol groups. Gel shrinkage leads to channel narrowing and ought to be prevented whenever possible. One approach to preserving an open structure is to support the pore structure against shrinkage with micelles formed by surfactant molecules. The surfactant molecules also lower the surface stress effectively, reducing the driving forces of shrinkage and surface condensation reactions.

Recently, scientists at DOE Pacific Northwest Laboratory¹⁷(PNNL) and Michigan State University¹ synthesized mesoporous silica (MS) materials containing functionalized organic monolayers that are very efficient in removing mercury from waste streams. The mesoporous silica material was prepared by mixing inorganic precursors in a solution containing surfactant micelles. The surfactants formed an ordered micelle structure. The precursors condensed around the regular structure forming a continuous silica phase. Subsequently, the surfactants were removed by thermal or chemical treatments leaving an ordered nanopore structure. See also, for example, U.S. Pat. Nos. 5,622,684, 5,834,391, 4,981,825, 5,114,691, 5,672,556, 5,712,402, 5,726,113, 5,785,946, 5,795,559, 5,800,799, 5,800,800, 5,840,264, 5,853,886, the disclosures of which are incorporated herein in their entirety by reference thereto.

The synthesis of a family of mesoporous molecular sieves (M41S)¹⁸¹⁹ as described above was first reported in 1992 by scientists at Mobil R&D (see also, for example, U.S. Pat. No. 5,145,816, U.S. Pat. No. 5,220,101, U.S. Pat. No. 5,378,440), the disclosures of which are incorporated herein in their entireties by reference thereto. They used cationic surfactants to assemble silicate anions from solution. The micellar assemblies of quaternary ammonium cations (cationic surfactant S⁺) are the structure-directing agents. The surfactants formed an ordered micelle structure. Their strong electrostatic interactions with anionic silicate oligomers led to condensation of inorganic precursors around the regular structure forming a continuous silica phase. There are three different members in the M41S family of materials: MCM-41 (hexagonal), MCM-48 (cubic), and MCM-50 (laminar). Since then, several other synthesis routes, involving different variations of charge matching and electrostatic interactions, were developed. The differences in pathways can be represented by the following combination of charge assemblies²⁰: (a). S⁺I⁻, (b) S⁻I⁺, (c) S⁺X⁻I⁻, (d) S⁻M⁺I^{°}, and (e) S^{°}I^{°} (product is called HMS), where, S: Surfactants, I: Inorganic Precursors, X: Halides (Cl⁻ or Br⁻), M: Metal ions (Na⁺, K⁺).

Removal of surfactants from the composites leads to mesoporous silica. The surfactants can be removed either by calcination or solvent extraction. Following the hydration of mesoporous silica surface (increasing surface silanol Si—OH population) the pore surface is incorporated with mercaptopropyltrimethoxysilane. Incorporation of ligands on the mesoporous silica developed by such a practice is much more effective than similar reaction with ordinary dry silica gel because of the increased access through the designed open channels in the former¹. Technology developed at PNNL demonstrated that using mesoporous silica with a chemically modified surface as an adsorbent elevated the efficiency of ion removal to a high level. The new material, called functionalized monolayers on mesoporous support (FMMS), has a distribution coefficient (metal weight percent in silica/metal ion weight percent in solution) as high as 340,000. The residual ion concentration after treatment is at the ppb (parts per billion) level.

While there have been significant advances in the art of mesoporous adsorbent technology still further improvements in performance and simplification of production would be highly desireable.

### SUMMARY OF THE INVENTION

The present invention, in one aspect thereof, provides an improved surface modified silica and a method for producing same, characterized by chemically modifying a freshly produced (i.e. gelled without prolonged aging) silica gel still in its wet state with molecular recognition ligand groups. This new class of silica-ligand composite, referred to herein as, Chemically Surface Modified Gel (CSMG), has a characteristic open pore structure as well as an exceptional high loading of surface ligands, both resulting from controlling the interfacial energy and processing kinetics during its preparation. Compared with existing art in the field, including the functionalized mesoporous silica mentioned above, products of this invention differ in at least the following categories:

(1) composition: much higher loading of ligands (e.g., 7.5 mmole per gram of support),

(2) morphology: open channels connecting nanopores; in preferred embodiment open channels connect micro- and nanopores,

(3) adsorption efficiency: majority of the loaded ligands are accessible,

(4) processing efficiency: significantly reduced processing time,

(5) solvent systems of processing: environmentally benign solvents,

(6) structure: amorphous, non-crystalline.

According to the calculation method reported in the literature (17), the surface density of fully dense monolayer coverage, as indicated by solid state NMR studies, was estimated to be 5×10¹⁸ molecules per square meter of surface area. Following the author's method of calculation, the ligand loading percentage on the silica surface achieved with the present invention is close to 100%. (Calculation is based on the loading of 7.5 mmole ligand per gram of silica, which was determined by the electron energy-dispersive spectroscopy (EDS) data shown later in the section of characterization data, for a specific surface area of 900 m²/g silica.) In addition, the utilization of the surface ligands of the CSMG derived by this invention for binding metal ions is far more efficient (rapid and complete) than the range observed with the existing art. (Adsorption tests done by mixing adsorbent with waste solution for one hour indicated that the utilization of the surface ligand group is >50% for this invention versus ≦25% for existing art). Although not intending to be bound by any theory of operation, it is believed that in the CSMG of this invention, the dense ligand groups are randomly distributed on the convex particle surfaces, therefore spread outwardly and are more accessible for binding metal ions from the solution.

The following table provides a direct comparison of the CSMG of this invention with existing art:

| | Range observed for | This invention |
|---|---|---|
| | existing art | (CSMG) |
| Ligand loading | 0.1˜5 mmole/g silica | ˜7.5 mmole/g silica |
| Adsorption | 0.1˜2.5 mmole metal/g | 3˜7.5 mmole metal/g |
| Efficiency | silica | silica |
| Morphology (Pore | One type, 2˜15 | Bimodal (10 nanometer |
| size distribution) | nanometer | and 10 micron)* |
| Reaction Time for | 12˜48 hours | 1˜2 hours |
| attachingligands | | |
| Solvent systems | Chloroform, toluene, | Water and ethanol** |
| for thiol ligand | benzene | |
| incorporation | | |
| *One scale (˜10 nanometer) of pores' are generated naturally with the silica gelation process, these are referred to in some literature as “mesopores”; additional open pores of micron sizes are artificially created with the addition of an insoluble liquid plus an appropriate surfactant to control the pore size. Some prior | | |
| # art, see, e.g., U.S. Pat. No. 5,622,684, in addition to mesopores include textural mesopores, however, these are only 1 to 2 order of magnitude larger than the framework-defined mesopores. In the present invention, the CSMG has a porosity of approximately 90% by volume and less than about 10% of the total pore volume is provided by the micropores. | | |

**The solvents combination for processing is specific to the choice of the ligand group; other combinations, e.g., water + methanol and water + tetrahydrofuran (THF), may be used depending on the molecular composition of the ligand group.

The present invention, in another apsect thereof, also relates to the chemically surface modified silica gel (CSMG) produced by the process of this invention. In still another aspect, the invention is directed to the use of the CSMG for removing metallic or non-metallic (e.g., organic) impurities from a liquid containing such metallic or non-metallic impurities. The invention also provides a method of forming a nanoporous wet open-cell silica gel precursor for the CSMG.

Thus, the present invention provides a process for the preparation of a new class of material, Chemically Surface Modified Gel (CSMG), suitable for the removal of heavy metal waste arising from aqueous streams such as those generated from decontamination and decommissioning operations, as well as for removing organic waste, such as large oil spills or chemical spills. Metal ions of interest that are covered by the Resources Conservation and Recovery Act (RCRA) include mercury (Hg²⁺), silver (Ag⁺), lead (Pb²⁺), cadmium (Cd²⁺), and copper (Cu²⁺). Some waste treatment facilities, such as, the DOE Weapons Complex, are subject to requirements that mandate very low levels for some metals in effluents (e.g. 0.004 mg/L silver) (U.S. Department of Energy, mixed Waste Focus Area, Technical Baseline Results, 1996). This requires technologies beyond commercially available ion exchange and specialty adsorbent systems. The present invention enables synthesis of CSMG with mercaptan functional groups attached to the surface. This material exhibits exceptionally high efficiency in adsorbing mercury ions. It is believed that the high efficiency is due to three factors: large surface area, high loading of mercaptan groups, and the low solubility product constant of HgS (Ksp=1.6×10⁻⁵²). Because of the low Ksp's of Ag₂S, PbS, CdS, CuS(6.69×10⁻⁵⁰, 9.05×10⁻²⁹, 1.40×10⁻²⁹, 1.27×10⁻³⁶ respectively), this CSMG is as effective in adsorbing Ag⁺, Pb²⁺, Cd²⁺, and Cu²⁺as it is in adsorbing Hg²⁺.

The present invention further provides a process which optimizes the attachment of molecular recognition ligand groups onto the surface of very high surface area and high porosity silica gels. In this process, the value of solubility product constants (Ksp) is used as guidance regarding the choices of effective functional groups. These CSMG materials can be made commercially viable based on the extremely low cost and easy processing of the substrate materials used. This will allow very efficient separation of toxic heavy metals from waste streams at cost effective rates. These adsorbents will also be useful for high-value applications in many other fields, including reaction catalysis, wherein, as well known in the art, the functionalized ligand groups have catalytic activity or adsorb metal ions which exhibit catalytic activity, as well as addressing specific industry needs, such as, for example, DOE Weapons Complex waste treatment facilities.

Thus, the process for producing a chemically surface modified silica gel according to this invention includes the following steps of:

(a) gelling a silica sol solution to form a wet silica gel;

(b) maintaining the silica gel at a temperature in the range of from about 40 to about 80° C. in a moist state to obtain a wet nanoporous silica gel having a popularity of open channels within the gel structure and silanol (Si—OH) groups on the surface thereof; and

(c) reacting with the silica precursor during gelling (one-phase process) or with the wet nanoporous silica gel after gelling (two-phase process) with, for example, a mercaptoalkyltrialkoxy silane, or other molecular recognition functional ligand group, to introduce a functionalized group effective for selective adsorption and/or reaction catalysis, preferably in an aqueous alcoholic medium under an inert atmosphere and at an elevated temperature within the range of from about 40° C. to about 80° C. to cause the functional ligand group e.g., mercaptoalkyltrialkoxy silane, to condense and react with the surface silanol groups to thereby obtain a chemically surface modified silica gel; and

(d) as necessary, drying the chemically surface modified silica gel.

The unique features of the CSMG derived from this invention are attributed to several novel processing practices employed in this invention, as described below. The incorporation of ligand groups is integrated with the preparation of the silica gel. According to one embodiment of the invention, the reaction of the ligand groups with the silanol groups in the silica occurs during the gelation reaction (one-phase process). In an alternative embodiment, the reaction of the ligand groups is carried out with the fresh (i.e. without substantial aging after gelling) wet silica gel after the gelation reaction (two-phase process). For both of these embodiments, using a wet gel, the solvent in the pores prevents shrinkage against surface stress and preserves the porosity and the open structure during processing. Moreover, a mixture of water and a ligand specific co-solvent is used as the solvent system during the gelation and the incorporation. of the ligand. In the example given below, ethanol, a low liquid, is used as co-solvent with the incorporation of mercaptopropyltrimethoxysilane. Using a low surface tension co-solvent such as ethanol reduces the interfacial energy of the modified silica particles considerably and, therefore, assists in the prevention or reduction of cell collapse.

The preservation of an open channel structure, as well as the reduction in interfacial energy by the co-solvent, not only improve the adsorption characteristics of the CSMG product but also considerably simplifies the processing procedures. The open channels and the reduced surface energy allow rapid diffusion of the ligand molecules. The rapid diffusion is further accelerated by the incorporation of micropores as previously described. Additionally, the processing of CSMG in this invention does not require pretreatment of the silica surface. The fresh wet gel contains many surface silanol groups which are strongly reactive to the ligand species. Contrary to a freshly prepared wet gel, an aged and dried silica gel does not have enough active silanol groups due to prolonged dehydration. The integration of ligand incorporation with the preparation of wet silica gel in this invention eliminates the lengthy drying (dehydration) and re-hydrolyzing (hydration) procedures which are inherent to other processes in existing art. The comparison of the CSMG (two-phase) process with the processes of making mesoporous silica-ligand composite in the following table illustrates this point clearly.

| Supporting Silica Substrate | | MCM-41 by S⁺I⁻ | MCM-41 by S⁺X⁻I⁺ | HMS by S°I° | Invention Sol-Gel |
|---|---|---|---|---|---|
| Preparation | Starting materials | Silica precursors | TEOS | TEOS | TEOS, Colloidal |
| of Nanopore | | CₙH₂ₙ₊₁N(CH₃)₃Br | CₙH₂ₙ₊₁N(CH₃)₃Br | CₙH₂ₙ₊₁NH₂ | silica, or Na₂SiO₃ |
| silica | Solvents | Water | Water | Water + Ethanol | Water + Ethanol |
| | Processing | Autoclave at 100° C. for | by stirring it at ambient | by aging it at | Stirring at 60° C. |
| | conditions | 6 days, or by aging it at | for 7 days | ambient for 18 | for 2 hours; aged at |
| | | ambient for 7 days | | hours | 60° C. briefly |

| | | |
|---|---|---|
| Calcination | 630° C. for 4 h (heating rate 2° C./min) | No need |
| Or Solvent | Hot (45° C.) EtOH for 1 hour, | |
| extraction | Filtered and washed with ethanol repeated (the last one in boiling EtOH) | |
| | Air dried in an oven at 80° C. for 1 hour | |

| Surface Modification | | PNNL Technology | MSU Technology | Invention CSMG |
|---|---|---|---|---|
| Incorporation of | Hydration of | Reflux with deionized water for 3-4 hours | HMS dried under | Wet silica gel with |
| mercapto- | silica | | vacuum at 100° C. | MPTMS in ethanol |
| propyltrimethyl | Condensation | Reflux with MPTMS in toluene for 4 hours | Reflux with | aqueous solution |
| silane | | May require overnight stirring and drying | MPTMS in toluene | stirred under |
| | | | for 48 hours | nitrogen at 60° C. |
| | | | | for 2 hours |
| | Solvents | chloroform, toluene, benzene (for different | Toluene | Water + Ethanol |
| | | approach and loading capacities) | | |

### BRIEF DESCRIPTION OF THE DRAWINGS

FIG. 1 is an EDS spectrum of silver-laden adsorbent according to the invention.

FIG. 2 is an IR spectra of (A) silica gel, (B) mercapto-functionalized silica gel, and (C) mercapto-functionalized adsorbent after silver (Ag⁺) adsorption, all according to this invention.

FIGS. 3, 4, 5 and 6 are SEM photographs at magnifications of 556×, 1112×, 2225× and 4450×, of a silica gel having bimodal pore size distribution according to the invention.

### DETAILED DESCRIPTION OF THE INVENTION

In the present invention, a silica gel is prepared from a precursor solution derived from tetraethoxyorthosilicate (TEOS), or collodial silica (for example, Ludox), or ion-exchanged sodium silicates, and the incorporation of a surface monolayer of functionalized ligand groups is integrated with the preparation of the silica gel (i.e. reacting during the gelation or immediately following the gelation before gel aging), thereby making the CSMG according to this invention. In order to have a compatible medium for incorporating the monolayer and a low interfacial tension for reducing the shrinkage of the gel, a specific solvent system may be chosen according to the composition of the ligand functional group. The choice of the functional group and the processing conditions of CSMG, including the solvent system, will dictate the adsorption efficiency of the final products. High adsorption efficiency may be achieved by (i) chemiadsorption of targeted ions on the surface; (ii) large surface area; (iii) open porous structure, and each of these factors is described in further detail.

(i) Cheiniadsorption of Targeted Ions on the Surface

The chemical properties of a gel surface are modified so that the target ions form chemical rather than physical bonds onto the surface. The modification with a ligand functional group increases the bonding energy of the metal ion to the silica surface sites. Increasing the bond energy will exponentially decrease the residual concentration of the ion in the solution at equilibrium. For example, at room temperature, reducing residual ion concentration from ppm (parts per million) to ppb(parts per billion) would require an increase of ca.17 kJ in bonding energy. By chemically modifying the gel surface with a selected functional group the difference. in energies of bonding the metal ion with the gel surface and solvating the metal ion in water could be effectively increased. This increase in bonding energy will result in a significant reduction in the residual concentration (ca. 6 kJ for a change of one order of magnitude in residual concentration) of the metal ion at adsorption equillibrium. The data of ion-ligand solubility product. constant (Ksp) may be used as a direct reference for selecting appropriate functional groups to control the residual ion concentration.

(ii) Large Surface Area

The accessible surface area of a low-density CSMG is very large. Because the silica particles are of nanometer size, the surface area of a low-density gel is in the range of from about 800 to about 1000 m²/g. It is two orders of magnitude higher than the surface area of ordinary ion-exchange adsorbent with a particle size of 1 micron or larger. This increase in surface area will result in a proportional increase in reaction speed of any interfacial reaction. Additionally, once loaded with functional groups, a large surface area leads to a greater adsorption capacity. Experimental results, as described below, clearly demonstrate this outstanding advantage of the surface modified nanogel. The present invention controls the gelation process to create the ideal gel morphology, i.e. a large surface area with many reactive silanol (Si—OH) groups (for the incorporation of surface functional groups). In particular, following the gellation reaction aging is limited to only a very brief duration, usually from about 30 to about 60 minutes, sufficient to allow secondary bond formation but too short for any significant degree of cross-linking or other pore collapsing reactions to occur.

In a gelation reaction, the backbone of the structure (long chain bonds) is formed rapidly at first, increasing the viscosity and slowing down additional bond formation. Aging after a gelation. reaction allows cross-linking (forming local ring-closing bonds). Forming a small ring structure enhances the mechanical strength of the gel, but also closes off some open channels. Both high mechanical strength and channel openness are generally required in field applications. In the present invention, therefore, the processing conditions are controlled in order to achieve an optimized morphology: a strong but open gel structure.

(iii) Open Porous Structure

In order to incorporate functional groups on the surface of a low-density silica gel while it is in a wet state, it is necessary to control the gel morphology and to minimize the surface tension of the solvent system in order to preserve the high surface area and maintain a large number of open channels. Replacing water with a solvent of low surface tension reduces the shrinkage. Literature reports²¹ also indicate that reacting surface silanol groups with organic molecules before drying could preserve the open pore structure. In the present wet gel process, the pores are filled with incompressible liquid, which provides support against capillary stress. Incorporation of HS—CH2—CH2—CH2—Si(OMe)₃ (MPTMS) onto the surface of a wet silica gel is achieved by using a mixture of solvents (water and ethanol) to lower the surface tension.

Additional open pores of micron sizes are created with the addition of an insoluble liquid plus an appropriate surfactant to control the pore size. These artificially created channels are intended for connecting the domains of nanopore silica in order to further facilitate the adsorption speed and efficiency.

Characterization of the Composite and Adsorptioin Capacities

The CSMG adsorbent material of this invention is essentially a tightly packed fractal-like arrangement of primary particles of approximately 10 nanometers particle size. The bulk density of the composite made by this invention is in the range of about 0.2 to 0.25 g/ml (determined with a Quantachrome mercury porosimeter). The specific surface area of the silica before the incorporation of the ligand groups is in the range of about 600 to 1100 m²/g. The skeletal density of the silica was measured with a helium pycnometer (Micromeritics, Pycnometer AccuPyc 1330). The specific surface area was characterized by gas adsorption (Micromeritics, Gemini Surface Area Analyzer). Other properties were calculated according to the following set of equations:

$$\begin{matrix}Pore Volume = ( \frac{1}{bulk density} ) - ( \frac{1}{skeletal density} ) \\ Pore Size = \frac{2 \times surface area}{pore volume} \\ Porosity = ( 1 - \frac{bulk density}{skeletal density} ) \times 100 \%\end{matrix}$$

Differences exist due to different degrees of gel shrinkage during drying before characterization.

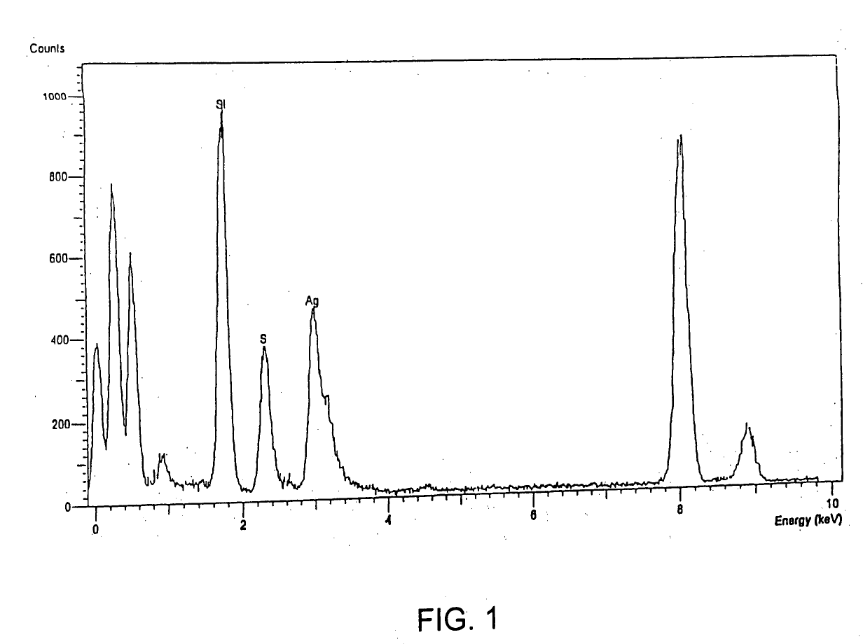

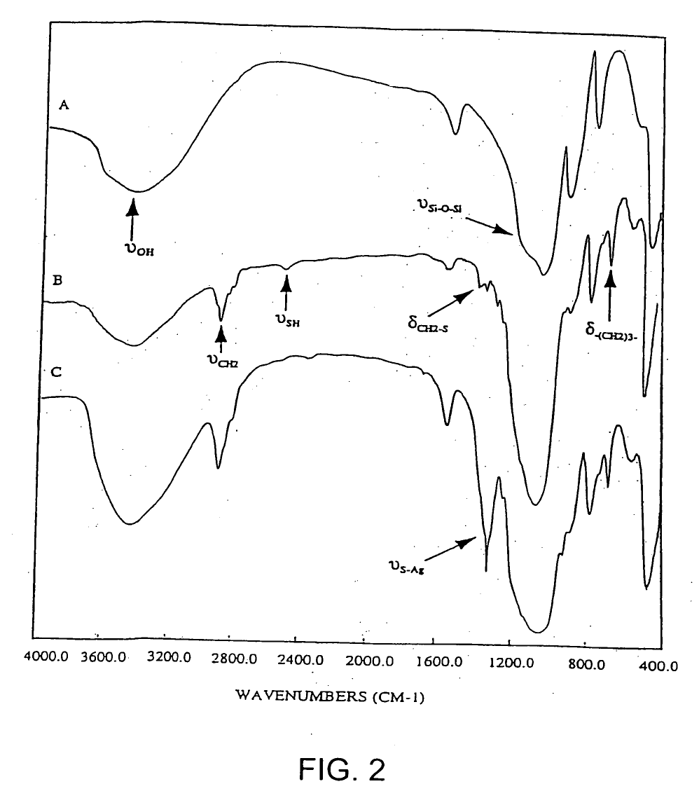

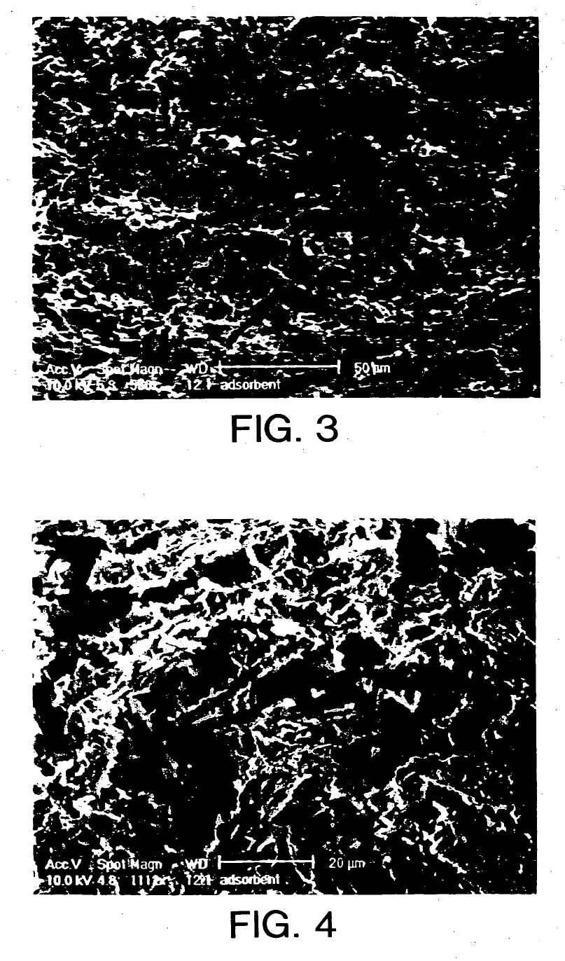

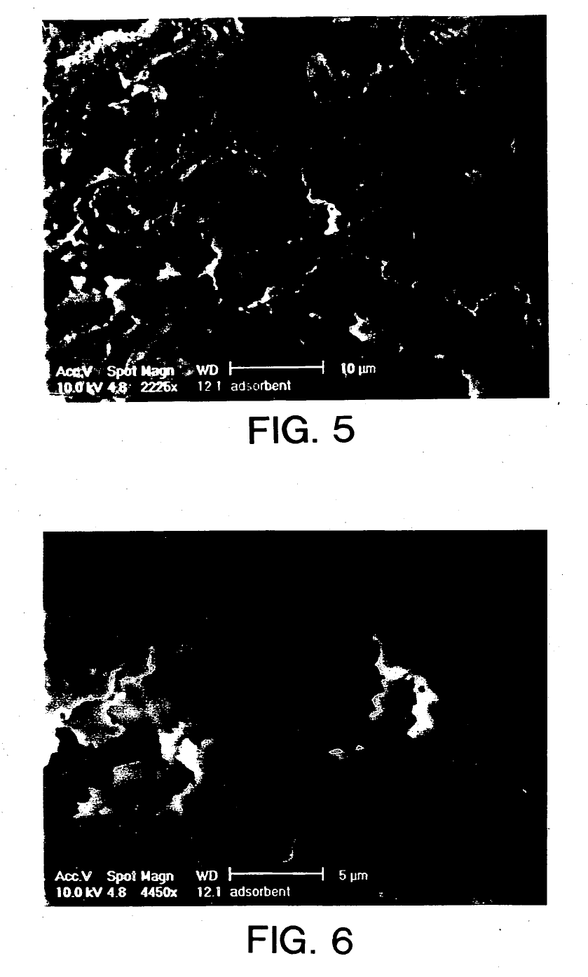

At the completion of the surface reaction, the CSMG is washed several times with water, replacing the solvent mixture. Two types of characterizations may be performed. First it is confirmed that the MPTMS has successfully formed a monolayer on the silica surface. This is done through NMR, IR, and EDS spectra. Compositional analysis indicates that the relative concentration of sulfur on the CSMG surface is correlated to both the ratio of MPTMS to silica and the reaction time. As expected, higher ratios of MPTMS to silica and longer reaction times result in more thiol groups on the surface. This in turn, yields improved heavy metal adsorption. Verification of bonding can be seen in the accompanying FIGS. 1 and 2.

EDS and IR spectrometric analysis were also performed on a representative silver laden sample. The EDS spectrum (FIG. 1) clearly indicates the presence of both sulfur and silver. The IR spectra of three forms of silica gel are shown in FIG. 2. The top curve (A), is for untreated silica gel. Strong adsorption bands at 1089 cm−1 and 3430 cm⁻¹ are attributed respectively to the stretching vibrations of Si—O—Si, and O—H on the surface. This should be compared to curve B, the spectrum for functionalized adsorbent. Here, bands at 2924 cm⁻¹, 2565 cm⁻¹, 1454 cm⁻¹, and 688 cm⁻ correspond to CH₂, SH, CH₂S, and —(CH₂)₃—, respectively, and show that MPTMS bonded to the surface of the silica. Finally, after silver ion adsorption (curve C), the band at 2565 cm⁻¹ disappears and one at 1384 cm⁻¹ results from the newly formed Ag—S bond. This clearly demonstrates that silver ions have bonded to thiol groups on the surface of the adsorbent.

Because 100% surface coverage of ligand can be obtained with the methods disclosed, this invention allows a complete range (from 0 to 100%) of surface coverage with the ligand groups through the control of reaction stoichiometry and kinetics. Partial coverage may be obtained with either a reduced degree of reaction (low reaction yield) or a lowered starting concentration for the ligand (longer processing time). The practical lower bound of the surface coverage by this invention for each kind of ligand group may be determined by the cost-effectiveness of producing the product under the constraints of the low reaction yield or the long processing time.

A second type of characterization allows for the determination of the efficiency as well as the capacity for metal ion adsorption by the CSMG. Atomic adsorption spectroscopy may be used to evaluate the concentration of metal ions before and after treatment with CSMG.

The efficiency of purification is characterized by the partition coefficient of metal ions distributed between the CSMG and the solution at equilibrium (i.e. weight % of ion in the CSMG divided by the residual weight % of ion in solution). The partition coefficient remains a constant at low adsorption concentration, equivalent to an equilibrium constant. At moderate to high adsorption, the coefficient is a function of adsorption concentration and ought to be characterized for a range of concentrations.

The following method may be used to evaluate the adsorption efficiency of the CSMG according to this invention.

To test the ability of adsorbent for purification of metal-contaminated water, a batch adsorption experiment at room temperature was performed. 10 mg of the adsorbent produced as in the following Example 2 was stirred with 50 ml of metal ion solution for 30 minute at initial concentration ranging from 5 to 10 ppm. Metal ion concentrations before (Cᵢₙᵢₜᵢₐₗ) and after (C_{eq}) treatment were determined by atomic adsorption spectroscopy. Results are shown in the following table.

| | | | | Partition coefficient |
|---|---|---|---|---|
| | | | Adsorption | mg per gram solid |
| | | | mg/g at | mg per gram |
| | Cᵢₙᵢₜᵢₐₗ(ppm) | C_{eq}(ppm) | equilibrium | solution |
| Ag⁺ | 7.2 | 0.002 | 35.99 | 17,995,000 |
| Pb²⁺ | 6.5 | 0.028 | 32.36 | 1,155,714 |
| Hg²⁺ | 6.6 | 0.004 | 32.98 | 8,245,000 |
| Cu²⁺ | 6.6 | 0.012 | 32.94 | 2,745,000 |

The capacity of adsorbing metal ion by an adsorbent varies significantly with the pH value of the solution. For mercaptan loaded CSMG, the adsorption capacity is expected to rise with the increase of the solution pH. For CSMG of this invention the following tests are performed to determine the adsorption capacity of respective metal ions at pH value of three.

To test the maximum adsorption of adsorbent, 140 mg of the same adsorbent was mixed with 200 ml solution, adjusted to pH=3, of respective metal ion for 1 hour at the initial concentrations indicated in the following table. Ion concentrations before (Cᵢₙᵢₜᵢₐₗ) and after (C_{final}) treatment were determined by atomic adsorption spectroscopy.

| | | | Adsorption | Capacity |
|---|---|---|---|---|
| | Cᵢₙᵢₜᵢₐₗ(ppm) | C_{final}(ppm) | (mg) | (mg/g adsorbent) |
| Ag⁺ | 970 | 475 | 99 | 707 |
| Pb²⁺ | 1130 | 953 | 35.4 | 253 |
| Hg²⁺ | 904 | 388 | 103 | 737 |
| Cu²⁺ | 930 | 760 | 34 | 243 |

It is believed that this is the highest metal ion adsorption reported for silica based adsorbents.
Representative Applications
Application 1. Waste Water Treatment

Approximately 10,000 tons of mercury are discharged into water or ground systems as industrial waste each year. Most removal operations require the separation of mercury ions from aqueous solution. Due to the high toxicity of the mercury ion, allowable concentration of the ion in the water after treatment is very low. Using the novel CSMG described herein would substantially lower the costs to reach the required low concentration, relative to other adsorption methods. According to the present invention, on the other hand, a gallon of the CSMG can treat up to 30,000 gallons of wastewater, reducing mercury concentration from ppm to ppb. A test of adsorption capacity indicates that one gram (dry weight) of CSMG substrate according to this invention can adsorb 0.7 g of mercury under acidic condition. From results of adsorption experiments and values of solubility product constants the inventive CSMG is also effective in treating wastewater containing silver (Ag⁺), lead (Pb²⁺), cadmium (Cd²⁺), and copper (Cu²⁺). All of these ions are major pollutants in various industries including those which manufacture batteries, computers, and photographic films. CSMG may be used for recovery use or waste clean up.

Application 2. Precious or Rare Elements Extraction

Precious metals and trace elements normally exist in very low concentrations. One major cost of a traditional process is extraction of these precious metals and trace elements from a low-concentration stock solution. In many cases, the preparation of high concentration and subsequent purification of the extract are the reasons for the high cost of these materials. CSMG may be used to extract low concentration (ppm level) metal ions selectively on to its surface. Due to its large surface area, CSMG can adsorb an amount almost equivalent to its own weight (see results of adsorption test). Thus, CSMG may be used to reduce the concentration and purification cost of these materials significantly.

Application 3. Drinking Water Purification

In Asia and elsewhere, the rapid industrialization and population growth has endangered the supply and the quality of drinking water. As a result of ineffective pollution control and a significant increase in water consumption, cities now face a crisis in supplying drinking water with acceptable quality. One proposed solution is to separate the water supply into two systems; one for drinking and another for other utility use. The CSMG of this invention may similarly be used for purifying water used to prepare bottled drinking water. The cost of bottled water in some areas is. higher than the price of gasoline. CSMG may be used in the purification of drinking water due to its high efficiency and loading capacity in ion adsorption.

Application 4. Solvent Purification for Electronic Application

Processing of microelectronics has become one of the fastest growing and most profitable businesses worldwide. Due to the dramatic progress in device miniaturization, microelectronics products have the highest value per unit of material used. Consequently, the microelectronics industry is capable of consuming many high technology and high-cost materials. One important requirement for solvent used in processing microelectronics is high purity. In particular, the ion concentration in the solvent must meet very strict standards. At present, the standard for allowable residual ions is being pushed from the sub-ppm level to the ppb level. Thus, in the extreme case of semiconductor processing, the solvents may require an on-site purification to remove contaminants occurring during its shipment. Reducing the ion level in a solvent from ppm to ppb is readily achievable due to the performance of CSMG with its comparable ease of processing.

Application 5. Preconcentration and Chromatography in Analytical Chemistry

CSMG adsorbent may be used for increasing the adsorption population of one specific ion or a group of ions. The large concentration difference for the specie in the CSMG adsorbent and in the solution presents application opportunities in analytical chemistry. Many analytical tests use only minute quantities of the sample. When the concentration of the specie of interest is too low, the amount can not be detected. Using CSMG to preconcentrate the specie allows the accurate determination of the specie content even when only a small amount of sample is being analyzed. Moreover, the high adsorption capacity of CSMG makes it an ideal packing substrate for high efficiency liquid chromatography. A short CSMG column may effectively separate ions with different partition coefficients.

The present invention thus provides a novel chemically modified silica gel substrate (CSMG) on the surface and pores of which there is incorporated a monolayer of ligand group (e.g., thiol). The starting silica material for. forming a silica sol solution used to form a wet silica gel, may be, for example, an alkoxy silane, especially tetraethoxy silane (TEOS), a colloidal silica precursor (e.g., Ludox), or a sodium silicate. The surface modification of the gel with, for example, mercaptopropyltrimethoxysilane, is done while it is still in a wet state (two-stage)or during the gelation reaction (one-stage). The adsorption efficiency of CSMG is more effective than the material made with mesoporous silicas. The invention CSMG is not only considerably more effective than adsorbents with similar composition, but in addition, may be produced with a much more efficient process. Using the process described above, the cost of producing the CSMG substrate is many times less than the cost of any other comparative substrate. The lower cost presents a significant advantage for any particular application (for example, wastewater treatment).

A silica gel made by a sol-gel process as described above normally contains tightly packed primary particles of size approximately 10 nanometers. As a result, the gel structure, packed from these primary particles, consists of open channels with a similar dimension (intra-particle channel size of approximately predominantly 10 nm). To facilitate and accelerate the diffusion of large species to and through these fine channels, a relatively small volume (e.g., about 10% of the total pore volume) of a second set of channels of micron size maybe artificially created during gelation to interconnect the finer (˜10 nm) channels. An insoluble liquid (e.g., chloroform) and a surfactant (any anionic type, e.g., sulfate, sulfonate, soap, etc.) may be used to create such an interconnecting structure. The surfactant is used to minimize the interfacial energy between the insoluble solvent phases, and its amount should be far less than required for forming micelles (i.e. surfactant concentration sufficiently lower than critical micelle concentration to avoid micelle formation), as used in prior art templating processes.

As illustrated by the above application examples, the present invention provides liquid, e.g., waste water and aqueous or non-aqueous solvents, purification using CSMG as a super adsorbent for heavy metal ions. Using the process for producing CSMG according to this invention and the resulting CSMG product, it is possible to achieve the following objectives:
To increase the strength of CSMG material
To control the structure-property relationship through processing parameters
To optimize the reaction kinetics
To improve the efficiency of processing
To incorporate other selective functional groups onto the gel surface
To develop techniques for recovering the adsorbed metal

These objectives are closely linked to the quality, cost, and processing, of the new CSMG product. Some of the properties and characteristics of the novel CSMG materials will now be described in further detail.

1. Strength of CSMG Material

The porosity of the silica gel is very high (approximately 90 to 97%). The degree of cross-linking is very low. Channels among silica particles are numerous and open. These characteristics are responsible for the fast and extensive ion adsorption. However, the mechanical strength of CSMG may, for the same reasons, be too low for some field applications. A weak and fragile substrate may be difficult to handle, especially for a large-scale industrial operation. Fine particles detached from a CSMG substrate could be a concern in an application, especially when they are loaded with toxic metal ions. Aging of the silica gel will increase the degree of cross-linking and improve the material strength. However, the degree of cross-linking must be controlled, as described above, so as not to close off the pore channels. Increasing the density with the use of a more concentrated sol , as described below) will also effectively strengthen the gel structure. Since the gelation of such a concentrated sol system is much faster, the reaction kinetics must be adjusted accordingly.

The strength of the wet gel may be increased by, for example, taking into account the bulk modulus of the porous silica. The bulk modulus of a porous silica can be expressed by an equation²² K=K_{°}(ρ/ρ_{°})ⁿ, where (ρ is density, K_{°} is modulus at the reference density, and n is from about 3 to about 4). Increasing bulk density from 0.1 to about 0.25 will increase the modulus by a factor of approximately 15. Besides density, the strength of a gel before and after drying depends on many kinetic factors such as aging, catalysis, reaction rate, etc. The kinetics of gel formation will determine the extent of the reaction and the initial microstructure of the gel, two important factors affecting K_{°}. Control of the kinetics of gelation to further increase K_{°} may also be accomplished.

Other techniques for increasing strength of the wet gel include using a concentrated sol solution and/or a layered silicate.

Concentrated Sol Solution

So far, in all systems that have been used for making gels, TEOS, Colloidal Silica, and Sodium Silicate, the silica content of the starting solution was low. To increase the final density, the silica content is increased to a desired level (e.g., >approximately 15%, e.g., about 20%) before gelation occurs, for example, by evaporating the solvent to increase the solids concentration. Solvent evaporation can be achieved either at an elevated temperature or a reduced pressure. The choice between these two conditions will be based on their effects on the kinetics of gelation of a high-concentration sol. For example, to prevent premature gelation, a low-temperature (e.g., below room temperature) and/or reduced pressure, evaporation might be necessary.

Layered Silicate

Increasing the. solid content may also be accomplished by the addition of fine particle clays (layered silicates) into the starting solution. Layered silicates have been used to strengthen aerogels in the past, and may similarly be used to strengthen the CSMG of this invention. Clays of from about 20 to 30 micron particle size are preferred. According to earlier experiments, aerogels made with the addition of clay greatly improves mechanical strength. Moreover, the plate geometry of a clay molecule provides a means for significantly altering physical properties in different directions with the control of the orientation of the plate molecules. Nanocomposites made of clay and polymers demonstrated exceptional improvement in thermal stability, thermal expansion coefficient, and reduced gas permeation. Adding layered silicates to CSMG will prevent the loss of detached particles during an adsorption operation.

Surface Modification and Cross-Linker

Surface modifications may also be used to improve gel strength. Since the surface functional groups of nanopore silica represent a large portion of the substrate, modification of them leads to changes in bulk properties as well. In addition, the population of the ligand groups and the repulsion between them slows down the condensation of silanol groups. It is known that aerogels made with extensive surface methylation can withstand the capillary stress incurred during drying under ambient conditions⁶. The 3-mercaptopropyl-trimethoxy-silane molecules incorporated on the surface have similar strengthening effects. As the loading of the surface monolayer is increased, mechanical strength of the CSMG improves as well. Other multi-functional oligomers (e.g., tri-[3-(trimethyloxysilyl)-propyl]isocyanurate) may be used to cross-link the CSMG for improving the strength. The size and stereochemistry of the oligomer molecules are screened so that incorporating them onto the CSMG surface will not block the diffusion of target metal ions.

2. Control of the Structure-Property Relationship Through Processing

As noted above, a great deal of the cost of producing CSMG is in material processing. The properties, and therefore the performances, of the CSMG material are closely correlated to the processing conditions. In order to produce the most effective (performance/cost) CSMG, the structure-property and morphology-processing relationships of the CSMG material is determined. This may be accomplished, for example, by characterization of the particular surface modification processing condition utilizing, for example, TEM, NMR, and/or IR to determine the effectiveness of the surface modification scheme.

The processing conditions for gels made from TEOS, colloidal silica, and sodium silicates, must be monitored very carefully. It is the solvent which creates the porosity in these systems. High porosity material is mechanically weak. During drying, capillary stress, resulting from surface tension of the meniscus in the pore, may shrink and crack the material. For pores of nanometer size the stress can be in the range of a hundred pounds per square inch. In the wet gel process according to this invention, the pores are filled with liquid, which is incompressible. The capillary stress will cause very little shrinkage because of the low compressibility of the liquid. During drying, however, the liquid turns into vapor, which is highly compressible, and the stress would tend to collapse the cells. Shrinkage resulting from cell collapse would reduce the porosity and may close off some open channels. Thus, the processing conditions of the gel may greatly affect the effectiveness of the subsequent surface modifications.

While much is known about the chemistry and kinetics involved in the gelation of plain silica sol, less detail is known about the variation of those parameters with the change in solvent content, silica density, temperature, and the pH. However, by controlling the kinetics of gelation using a solvent mixture with a low surface tension, a concentrated sol solution, and/or lower temperature, the reaction speed may be controlled so that the morphology and processing are optimized. Layered silicates may be used to strengthen the gels, as described above. However, care must be taken that these added ingredients do not alter the effectiveness of the modification reaction.

Using a series of controlled experiments and characterization work the effects of processing conditions on the overall adsorption efficiency of CSMG may be readily ascertained. Determination of the efficiency of adsorption in broader terms, including the extent of the adsorption, the speed of the adsorption, the effects of physical (for example, temperature) and chemical (for example, pH, other ionic species, etc.) environments on the adsorption and other interfering factors will then be known.

3. Optimization of Reaction Kinetics

One major advantage of a silica sol-gel system in processing is that the gelation kinetics can be easily controlled with the adjustment of the pH value. For an industrial product, a faster reaction usually allows a shorter processing time and a lower fixed (manufacturing) cost. Of course, the gelation must also be slowed down enough so that other processing procedures can catch up with the gelation. The control of gelation kinetics is critical because the microstructure and the mechanical properties of a silica gel are dictated by it. Optimization of the reaction kinetics is further required due to the fact that the effectiveness of the surface modification is very sensitive to the properties and thus, the processing of the silica gel.

The reaction for loading ligand groups onto silica gel surfaces and subsequent treatments generally takes a couple of hours. The reaction rate, the reaction temperature, the pH, the initial gel morphology, are factors which may be controlled to optimize the rate of the surface modification reaction and/or to achieve a higher percentage of loading within a reasonable reaction time. A higher loading of functional groups is effective to increase the adsorption efficiency and, in some cases, to improve the strength of the CSMG as well.

4. Efficiency of Processing

An industrial process, differing from a laboratory process, must deal with a very large quantity of materials. Consequently, many issues, which are negligible on a laboratory scale, must be addressed properly during scaling up. For example, VOC (volatile organic compound), solvent recovery, fire hazards, waste treatments, scrap reuse are all important issues for industrial processing. Since CSMG is made from a low-density gel, the volume of solvent used for the reaction and washing is several times larger than the actual volume of the product. Even though relatively safe ethanol may be used in place of benzene, the amount of solvent needed for processing may still present a problem in large scale production. However, those skilled in the art, will be able to design an efficient processing system so that all the processing issues mentioned above are satisfactorily addressed.

The conditions used in batch procedures may be adopted for a semi-continuous process. In particular, the reaction rates of each individual component are adjusted so that the flow of materials for the process are synchronized. In a continuous process the majority of the production may be carried out in an extruder. The extruder may have many different zones, each one being designated for a different reaction.

5. Incorporation of Other Selective Functional Groups

Initial work incorporated the mercaptan functional group on the silica gel surface. Metal ions that normally precipitate with the sulfide ion (low solubility product, Ksp) are exhaustively adsorbed. By determining the solubility product value of different ion pairs other new surface modification schemes may be designed. Ksp and bonding energies may be utilized to choose the appropriate functional groups to be incorporated in the CSMG. As explained previously, solubility product constant (Ksp) is a direct indication of what type of functional group to choose for a specific ion. Bonding energies of a precipitate or a complex ion may be used to estimate the effectiveness of adsorption. The free energy of the adsorption may be calculated and the partition coefficient, Kp (surface ion concentration/residual ion concentration), may be estimated, accordingly. Since in most cases, only very diluted solutions will be treated with the CSMG, the ideal solution scenario may be used to obtain the entropy. For the species adsorbed on the surface, the entropy may be calculated by using a two-dimensional lattice model.

In qualitative analysis a group of ions can be selectively precipitated with one common ion; likewise, a functional group incorporated at the silica gel surface may selectively adsorb a group of counter ions as desired. Following traditional qualitative analytical chemistry (of separating ions in solution) choices of additional functional groups for ion removal may be selected. Successful incorporation of new functional groups will extend the applications of CSMG as a product, and will also simplify the procedures of using CSMG for water or solvent purification. For instance, a multi-zone column packed with CSMG of different functional groups may be used to achieve a complete purification with just one flow through the column.

Thus, as examples of representative suitable functional group providing ligands, mention may be made of, for example, mercaptans, such as, 3-mercapto-(mono- or di)-alkyl(di- or tri-)alkoxy silanes, e.g., 3-mercaptopropyltrimethoxysilane, 3-mercaptopropyltriethoxy silane, 3-mercaptopropylmethyldimethoxy silane; amines, such as, 3-aminopropyltrimethoxysilane, 3-aminopropyltriethoxysilane, ethylenediamine mono-, di-, tri- or tetra-acetate, and the dithiocarbamate derivative thereof, N-[3-(trimethoxysilyl)propyl]ethylenediamine and the triacetic acid trisodium salt thereof; amides, such as chitin and chitin derivatives, e.g., chitosan; and the like. Other known chelating agents, such as, for example, 1-nitroso-2-naphthol, 5-sulfodimethylisophthalate salts, e.g. Na, 8-quinolinol; and ion-exchange resins as well known in the art may also be used as the functional group providing ligands for the CSMG adsorbents of this invention. In this regard, mention is made of the literature references²³-³⁹, in the attached list of references, forming part of this application, and which references are incorporated herein in their entirities by reference thereto.

6. Techniques for Recovering Metal from a Waste Stream

The high loading capacity of CSMG at saturation (about 0.7 gram Hg/gram CSMG) provides an opportunity for recovering the metals from CSMG after wastewater treatment. There are-at least two options available for removing metal ions from the surface of CSMG. One is to change the partition coefficient of the adsorbed metal ion by varying the temperature and/or the pH of the solution. Regeneration of used CSMG material with recovery of adsorbed metal ions may be achieved using, for example, a concentrated HCl solution. This will significantly increase the concentration of the metal ion in the solution and lead to a regeneration of the CSMG surface. The regenerated materials will retain high loading capacity and remain effective even after several cycles. Dissolving the CSMG in a hot basic solution will also result in a separation of the metal ion from the CSMG surface. After being relieved from the CSMG surface, the metal ions can be reduced to metal through chemical reaction or electrolysis. With a recovery option, the CSMG wastewater treatment bridges a complete cycle for the use of heavy metal materials.

The following experimental procedures are disclosed merely as examples of practicing this invention according to the detailed principles described above. Many variations in practices of this invention within the boundary of the working principles and the scope of the claims may be recognized by those skilled in the art according to the principles and examples disclosed.

### EXAMPLE 1

### Producing CSMG from TEOS by Two-Phase Processing

Silica sol is prepared from TEOS, H₂O, ethanol and HCl, in the total molar ratio 1:2:4:0.0007. The mixture of TEOS, H₂O, ethanol and HCl is stirred at 60° C. for 2 hours. A NH₄OH solution and variable amount of water is added to adjust the pH to 6 to 7 and to gel the mixture. Gelation normally occurs within a few minutes. The obtained wet silica gel is aged at 60° C. briefly (about 30 to 60 minutes) and washed with ethanol and water separately.

The mixture of 50 g of wet silica gel and a variable amount (depending on the desired % of ligand loading) of 3-mercaptopropyltrimethoxysilane is added into a reaction vessel equipped with agitator, heating mantel, thermometer and nitrogen purge system. A solution of water and ethanol is used as the reaction medium. The amount of ethanol in this mixed solvent should be adjusted according to the amount of ligand desired in the mixture. The reaction mixture is heated to 50-60° C. for from 1 to 2 hours. After cooling down to room temperature, the product is filtered and washed thoroughly with ethanol and water successively.

### EXAMPLE 2

### One-Phase Processiig of CSMG

Silica sol is prepared from TEOS, H₂O, ethanol and HCl, in the total molar ratio 1:2:4:0.0007. The mixture of 50 ml of silica sol and a variable amount (depending on the desired % of ligand loading) of 3-mercaptopropyltrimethoxysilane is added into a reaction vessel equipped with agitator, heating mantel, thermometer and nitrogen purge system. Additional amount of water or ethanol is used to adjust the water/ethanol ratio in the solvent mixture so that their proportions are suitable for the amount of ligand desired. The reaction mixture is heated to 50-60° C. from 1 to 2 hours. Then, a NH₄OH solution is added to the mixture to induce gelation. After cooling the CSMG is filtered and washed thoroughly with ethanol and water successively.

### EXAMPLE 3

### Incorporation of a Ligand Group Different than Thiol

Separately following the procedures of Example 1 and Example 2, 3-aminopropyltrimethoxysilane or chitosan are incorporated onto the surface of the silica gel with high loading, respectively, by the two-phase or one-phase embodiments.

### EXAMPLE 4

### Creating Micron-Size Interconnecting Channels

Following procedures in Example 2 to create a one-phase mixture of ligand and silica sol, the reaction mixture is heated to from 50 to 60° C. for from 1 to 2 hours. After the mixture is cooled down to room temperature, 2 ml of chloroform. and 0.2 to 0.5 gram of sodium dodecyl sulfate in water (2 to 5 ml) is added to the mixture. The mixture is heated to 30 to 40° C. with vigorous stirring for 1 hour. Then, a NH₄OH (1N) solution is slowly added to the mixture until gelation occurs. After aging at 30 to 40° C., the product is filtered and washed thoroughly with ethanol and water successively.

### EXAMPLE 5

Silica sol is prepared from 100 g Nalcol 115 by adding 10 ml of 1M H₂SO₄ to adjust the pH to 6.78. The mixture gels within 30 minutes at room temperature.

A mixture of 50 g of wet silica gel and a variable amount (depending on the desired % of ligand loading) of 3-mercaptopropyltrimethoxysilane is added into a reaction vessel equipped with agitator, heating mantel, thermometer and nitrogen purge system. A solution of water and ethanol is used as the reaction medium. The amount of ethanol in this mixture solvent is adjusted according to the amount of ligand desired in the mixture. The reaction mixture is heated to 50 to 60° C. for from 1 to 2 hours. After cooling down to room temperature, the product is filtered and washed thoroughly with ethanol and water successively.

While the invention has been described above in connection with silica based CSMG and silica gel precursors, the invention is equally applicable to other metal oxide adsorbents, such as, for example, alumina, zirconia, titania, and the like, including mixtures of metal oxides. As well known in the art gels of the metal oxides may be prepared similarly to the preferred silica gels, such as, for example, from the corresponding metal hydroxide precursors.

### LIST OF REFERENCES

1. L. Mercier and T. Pinnavaia, Adv. Mater., 9, No. 65, pp 500-503 (1997).
2. L. Mercier, C. Detellier, Environ. Sci. Technol., 29, p 1316 (1995).
3. M. S. Iamamoto, Y. Gushikem, J. Colloid Interface Sci., 129, p 162 (1989).
4. E. I. S. Andreotti, Y. Gushikem, J. Colloid Interface Sci., 142, p 97 (1991).
5. W. C. Moreira, Y. Gushikem, O. R. Nascimento, J. Colloid Interface Sci., 150, p 115 (1992).
6. U.S. Pat. No. 5,814,226, September 1998, Lawrence L. Tavlarides, Nandu Deorkar.
7. U.S. Pat. No. 5,817,239, October 1998, Lawrence L. Tavlarides, Nandu Deorkar.
8. D. E. Leyden and G. H. Luttrell, Analytical Chemistry 47(9): pp 97-108 (1976).
9. D. E. Leyden and G. H. Luttrell, Analytica Chimica Acta, 84, pp 97-108 (1976).
10. M. C. Gennaro, E. Mentasti, and C. Sarzanini, pp 1013-1015 (1985).
11. K. Ohshima, H. Watanabe, and K. Haraguchi, Analytical Sciences, vol. 2, pp 131-135 (1986).
12. A. Tong, Y. Akama, and S. Tanaka, Analytica Chimica Acta 230: pp 179-181 (1990).
13. I. P. Alimarin, V. I. Fadeeva, et al., Talanta 34(1); pp 103-110 (1987).
14. T. I. Tikhomirova, V. I. Fadeeva, et al., Talanta 38(3): pp 267-274 (1991).
15. H. Ince, S. Akman, and U. Koklu, Fresenius Journal of Analytical Chemistry 342: pp 560-562 (1992).
16. E. M. Soliman, Analytical Letters 30(9): 1739-1751 (1997).
17. X. Feng, G. E. Fryxell, L. O. Wang, A. Y. Kim, J. Liu and K. M. Kemner, Science, 276, pp 865.
18. J. S. Beck, et al., J. Am. Chem. Soc., 114, 10384 (1992) C. T. Kresge, et al., Nature, 359, 710 (1992).
19. J. S. Beck, et al., Chem. Mater. 6, 1816 (1994).
20. P. T. Panex, T. J. Pinnavaia, Chem. Mater. 8, 2068-2079 (1996).
21. R. Deshpande, et al., in: Better Ceramics Through Chemistry V, ed. M.J. Hampden-Smith, et al. (Materials Research Society, Pittsburgh, Pa.) p. 553 (1992).
22. G. W. Scherer, Non-Cryst. Solids 109, p. 183 (1989); T. Woignier, et al., J. Mater. Res. 4, p. 688 (1989); J. D. Lemay, et al., Better Ceramics Through Chemistry IV, ed. C. J. Brinker, et al. (Materials Research Society, Pittsburgh, Pa.) p. 321 (1990).
23. Aly Sayed Aly, et al., Korea Science and Engineering Foundation, 10 Feb. 1997, pp 1939-1946.
24. M. C. Gennaro, et al., Dipartimento di Chimica Analitica, 23 Oct. 1985, pp 1013-1015.
25. Hurrem Ince, et al., Fresenius J Anal Chem (1992) 342: pp 560-562.
26. Yun Heum Park, et al., Department of Textile Engineering, 28 June 1996, pp 773-778.
27. Gayle E. Morris, et al., Journal of Colloid And Interface Science, 190, pp 198-205 (1997).
28. M. E. McComb, et al., Analytica Chimica Acta 341 (1997) pp 229-239.
29. F. Sebesta, Journal of Radioanalytical and Nuclear Chemistry, vol. 220, no. 1 (1997) pp 77-88.
30. Katsuo Ohshima, et al., Analytical Sciences, April 1986, vol. 2, pp 131-135.
31. Ezzat M. Soliman, Analytical Letters, 30(9), 1997, pp 1739-1751.
32. A. Tong, et al., Analytica Chimica Acta, 239, 1990, pp 179-181.
33. Donald E. Leyden, et al., Analytical Chemistry, vol. 47, no. 9, August 1975, pp 1612-1617.
34. I. P. Alimarin, et al., Talanta, vol. 34, no. 1, 1987, pp 103-110.
35. G. V. Myasoedova, et al., Talanta, vol. 32, no. 12, 1985, pp 1105-1112.
36. T. I. Tikhomirova, et al., Talanta, Vol. 38, no. 3, 1991, pp 267-274.
37. A. G. Chmielewski, et al., Hydrometallurgy, 45 (1997) pp 333-344.
38. Donald E. Leyden, Analytica Chimica Acta, 84 (1976) pp 97-108.
39. Ali Mohammad, et al., Journal of Scientific & Industrial Research, vol. 56, September 1997, pp 523-539.

1. A method of producing a nanoporous open-cell functionalized silica gel having a plurality of open channels within the gel structure and silanol (Si—OH) groups on the surface comprising
(a) gelling a silica sol solution to form a wet silica gel;
(b) maintaining the silica gel at a temperature in the range of from about 40 to about 80° C. in a moist state under conditions to obtain a wet nanoporous silica gel having a plurality of open channels within the gel structure and silanol (Si—OH) groups on the surface; and
(c) reacting a ligand group with the surface silanol groups to introduce a functionalized group effective for selective adsorption or reaction catalysis.

2. A method for producing a chemically surface modified silica gel comprising:
(a) gelling a silica sol solution to form a wet silica gel;
(b) maintaining the silica gel at a temperature in the range of from about 40 to about 80° C. in a moist state to obtain a wet nanoporous silica gel having a plurality of open channels within the gel structure and silanol (Si—OH) groups on the surface thereof; and
(c) reacting the wet nanoporous silica gel with a reactive ligand introducing compound in an aqueous alcoholic medium under an inert atmosphere and at an elevated temperature within the range of from about 40° C. to about 80° C. to cause the ligand introducing compound to condense and react with said surface silanol groups to thereby obtain said chemically surface modified silica gel; and
(d) optionally, drying the chemically surface modified silica gel.

3. A method for producing a chemically surface modified silica gel comprising the steps of:
(a) reacting a silica precursor with a reactive ligand introducing compound in an aqueous alcoholic medium under an inert atmosphere and at an elevated temperature within the range of from about 40° C. to about 80° C. to cause the ligand introducing compound to condense and react with said silanol groups before gelation and subsequently adjusting the pH value of the solution to induce gelation, to thereby obtain said chemically surface modified silica gel; and
(b) optionally, drying the chemically surface modified silica gel.

4. A chemically surface modified silica gel produced by the method of claim 1.

5. A chemically surface modified silica gel produced by the method of claim 2.

6. The chemically surface modified silica gel according to claim 5 wherein the ligand introducing compound is 3-mercaptopropyltrialkyoxysilane.

7. A chemically surface modified silica gel produced by the method of claim 3.

8. The chemically surface modified silica gel according to claim 7 wherein the ligand introducing compound is 3-mercaptopropyltrialkyoxysilane.

9. A method of removing metallic impurities from a liquid which comprises contacting the liquid with the chemically surface modified silica gel of claim 1.

10. A method of concentrating metallic content in a liquid which comprises contacting the liquid with the chemically surface modified silica gel of claim 1.

11. A method of separating two or more metallic impurities from a solution of the mixture of metallic impurities which comprises passing the solution mixture through a column packed with the chemically surface modified silica gel of claim 1.

12. A method of recovering metal from a low-concentration feed solution which comprises contacting the feed solution with the chemically surface modified silica gel of claim 1.

13. A method of producing a nanoporous open-cell silica gel having a plurality of open channels within the gel structure and silanol (Si—OH) groups on the surface comprising
(a) gelling a silica sol solution to form a wet silica gel; and
(b) maintaining the silica gel at a temperature in the range of from about 40 to about 80° C. in a moist state to obtain a wet nanoporous silica gel having a plurality of open channels within the gel structure and silanol (Si—OH) groups on the surface.

14. A method for preparing a chemically surface modified silica gel effective for adsorbing a target specie from a liquid containing said target specie suspended or dissolved therein, said method comprising
(1) selecting a ligand molecule having a first functional group at one end thereof reactive with the silanol groups of silica and a second functional group at an opposed end thereof, said second functional group strongly binding to said target specie, as determined by at least one of bond energy between the second functional group and target specie or solubility product constant, Ksp; and
(2) reacting wet silica gel with the selected ligand in a hydrophilic co-solvent.

15. A chemically surface modified silica gel produced by the method of claim 14 which further comprises
(a) gelling a silica sol solution to form a wet silica gel;
(b) maintaining the silica gel at a temperature in the range of from about 40 to about 80° C. in a moist state to obtain a wet nanoporous silica gel having a plurality of open channels within the gel structure and silanol (Si—OH) groups on the surface thereof; and
(c) reacting the wet nanoporous silica gel with a reactive ligand introducing compound in an aqueous alcoholic medium under an inert atmosphere and at an elevated temperature within the range of from about 40° C. to about 80° C. to cause the ligand introducing compound to condense and react with said surface silanol groups to thereby obtain said chemically surface modified silica gel.

16. A chemically surface modified silica gel produced by the method of claim 14 which further comprises reacting a silica precursor with said selected ligand molecule in said hydrophilic co-solvent under an inert atmosphere and at an elevated temperature of from about 40° C. to about 80° C. to cause the selected ligand molecule to condense and react with said silanol groups before gelation and subsequently adjusting the pH value of the solution to induce gelation.

17. A method of separating a target specie from a ligand containing said target specie which comprises contacting the liquid with the chemically surface modified silica gel of claim 15.

18. A chemically surface modified silica gel according to claim 15 wherein said second functional group strongly binds to an organic target specie.

19. A method for removing oil or other organic chemical contaminant spilled on the surface of a body of water, comprising contacting the contaminated surface of said body of water with the chemically surface modified silica gel according to claim 18 whereby the oil or other organic chemical contaminant at least substantially adsorbed by said gel and thereafter removing the gel from the surface of said body of water.

20. A chemically surface modified amorphous silica gel adsorbent comprising
(i) bimodal pore size distribution of pores having pore diameters of about 10 nanometers and about 10 microns;
(ii) ligand loading of about 7.5 mmole ligand per gram silica gel; and
(iii) bulk density in the range of from about 0.2 to about 0.25 g/ml.

21. The silica gel adsorbent according to claim 18 wherein said ligand comprises 3-mercaptopropyltrialkoxysilane.
